(19) United States
(12) Patent Application Publication
(10) Pub. No.: US 2005/0244064 A1
(43) Pub. Date: Nov. 3, 2005

(54) Processing a media signal in a media system to prevent overload

(75) Inventors: Christian Hentschel, Eindhoven (NL); Maria Gabrani, Gattikon (GR); Reinder Jaap Bril, Eindhoven (NL); Elisabeth Francisca Maria Steffens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/515,731

(22) PCT Filed: May 16, 2003
(86) PCT No.: PCT/IB03/02054

§ 371 Date: Nov. 24, 2004

(30) Foreign Application Priority Data
May 30, 2002 (EP) 02077135.8

(51) Int. Cl. G06K 9/36

(52) U.S. Cl. 382/239

(57) ABSTRACT

This invention relates to processing of a media signal in a media system. The media system can be a PC, a Digital TV, a Settop-Box or a Display. The method includes the steps of: monitoring, by a system control unit, a progress and a resource usage (18) of the processing of the media signal; determining, by a structural load control or indicator unit, a first point in time (1) for a substantial load change (19) of a content; determining, by the system control unit, a second point (2) in time based on the first point; decreasing, by the system control unit, an assigned quality level (13) of at least one scalable algorithm at the second point in time; and adapting, by the system control unit, the assigned quality level of at least one scalable algorithm at or till a third point in time, wherein a realized quality level (17) will become stable within a period of adaptation time. Said substantial load change of content can be caused by a shot or a scene change. The scalable algorithm can be without error propagation. Said second point in time can come before, coincide with or come after the first point in time. The adaptation time can be in the range of fractions of a second. This enables minimization of a time of non-optimal data dependent system behavior, and of its effects on a visual output quality.

This invention relates to processing of a media signal in a media system.

The present invention also relates to a computer system for performing the method.

The present invention further relates to a computer program product for performing the method.

This invention further relates to a media system for processing a media signal.

EP 0,957,177 discloses a coder producing a signal. The coder comprises a quantizer for quantizing an input signal, an encoder for encoding the output of the quantizer and outputting coded data. It uses a scene change detector for detection of a scene change, and if the scene change is detected, a quantizing parameter adapted to the scene is supplied to the quantizer to a scene newly appearing after said scene change. The coder is used to produce a signal of quality at a low coding rate.

It is known that a system for video signal processing can be in an unpredictable state when a data dependent load of a software media processing algorithm becomes higher than its assigned or available resources after a scene change. In the worst case scenario the system crashes. During the system crash, and before the system recovers from the crash, there will a period of unreliable system behavior or at least a period of system behavior that unfortunately depends on and is affected by non-optimal data load(s). As a consequence, during said period, the non-optimal system behavior of the video signal processing system will degrade the visual output quality, which is annoying to an end-user.

It is therefore an object of the present invention to minimize the time of non-optimal data dependent system behavior, and its effects on the visual output quality.

The object is achieved by a method of the type mentioned in the opening paragraph, the method comprising the steps of:
monitoring, by a system control unit, a progress and a resource usage of the processing of the media signal;
determining, by a structural load change detector, a first point in time for a substantial visual change of a content;
determining, by the system control unit, a second point in time based on the first point;
decreasing, by the system control unit, an assigned quality level of at least one scalable algorithm at the second point in time; and
adapting, by the system control unit, the assigned quality level of at least one scalable algorithm at or till a third point in time, wherein a realized quality level will become stable within a period of adaptation time.

In the first step, generally, the system control unit may have to monitor the resource usage and the progress to be able to recognize the current status of the media system media signal processing.

This is, in general, the reason, why the scene change detector or the structural load detector may help to protect the media system in that it has information about the progress and the resource usage in order to avoid or to prevent an eventually, subsequent overload or system crash.

In the second step, a first point in time is determined for a subsequent shot or scene change before one of these actually occurs; in the third step, a second point in time closely related to the first point in time is then determined; and in the fourth step—at the second point in time—an assigned quality level is decreased in order to actively release resources to avoid or prevent an overload of resources, i.e. to prevent that said data load of a software media processing algorithm becomes higher than assigned or available resources thus avoiding previously mentioned system crash. Finally, in the fifth step,—at or till said third point in time—the assigned quality level is adapted again in order to make the realized quality level to become stable.

The object of the invention—i.e. to minimize the time of non-optimal data dependent system behavior, and its effects on the visual output quality—is achieved since—in the time from said second point in time (from the fourth step) and until the realized quality level is once again stable (in the fifth step), the processing of the media signal in the media system is controlled by said decrease and subsequent adapting of the assigned quality, thus preventing unreliable non-optimal data load(s).

It is therefore an advantage of the invention to prevent overload by means of the above-mentioned steps.

The term of “scene change” known from the prior art may be expanded to also cover situation of a shot change as well. The shot change—as compared to the scene change—concerns change(s) within the scene, e.g. different views of people and/or different views in a room.

One of these changes was determined in the first step, i.e. “substantial visual change of a content”.

In a preferred embodiment of the invention, said step of determining a first point in time comprises the steps of:
deriving, by the structural load control or indicator unit, information about at least one future visual change of the media signal; and
transferring, by the structural load control or indicator unit, said information to the system control unit

In these two steps, the structural load control or indicator unit may derive information about at least one future visual change of the media signal, i.e. information about a scene change and/or a shot change, and then transfer it to the system control unit, where the point in time for said scene change or shot change is subsequently determined.

In a preferred embodiment of the invention said scalable algorithm is without error propagation.

In another preferred embodiment of the invention, the second point in time comes before the first point in time; alternatively, the second point in time coincides with the first point in time; or alternatively, the second point in time comes after the first point.

In a preferred embodiment of the invention said period for the adaptation time is in a time scale of fractions of a second, prefereably less than one second.

In a preferred embodiment of the invention media system is a PC, a Digital TV, a Settop-Box or a Display.

The object of the invention is further solved by a media system for processing a media signal comprising:
means for monitoring a progress and a resource usage of the processing of the media signal;
means for determining a first point in time for a substantial load change of a content;
means for determining a second point in time based on the first point;
means for decreasing an assigned quality level of at least one scalable algorithm at the second point in time; and
means for adapting the assigned quality level of at least one scalable algorithm at or till a third point in time, wherein a realized quality level will become stable within a period of adaptation time.

In a preferred embodiment of the invention, the media system's means for determining a first point in time comprises:
means for deriving information about at least one future visual change of the media signal; and
means for transferring said information to the system control unit.

The media system provides the same advantages for the same reasons as described previously in relation to the method.

Hereby the present invention utilizes the capabilities of scalable video algorithms and exploits the fact that the human visual system (HVS) needs a short time to adapt to shot or scene changes. Generally, the scalable video algorithm(s) may reduce their quality level upon or before notification of the scene or load changes, freeing in this way resources, speeding up processing of the media signal and avoids previously mentioned overload or crash. The reduction (i.e. said decrease) in quality may be recovered within said time equivalent to the adaptation time of the HVS, and is therefore not annoying to a user of the media system.

For a background information, prior to a detailed discussion of the invention, the following paragraph should be considered as an introduction to various terms, which will be used in the following:

The video algorithms that are used currently in consumer applications are designed to have a high quality. Highquality is particularly eminent in case of single-function hardware components. Software video algorithms can be designed in several processing configurations to allow for different output quality levels in exchange of the required resources. Such software video algorithms can be named scalable video algorithms (SVAs). The scalability of the video algorithms allows a larger number of applications to run concurrently in a programmable component thereby improving the cost-effectiveness of the system. SVAs are controlled at run-time in their resource and quality behavior. The response to the run-time control may be realized by a control part of the SVA(s) that translates the assigned quality level to the SVA by the overall system control unit, to the appropriate processing configuration (realized quality level).

Instead of assigning quality levels it is also possible to assign budgets for resource usage, which anticipates a quality level. The really consumed budget may differ especially when the resource usage is data dependent.

The overall system control unit may allocate resources to processing algorithms (SVAs) based on average resource needs, in this way allowing more applications to run concurrently, and thus improving the cost-effectiveness of such as system. If the load of an SVA is higher than initially claimed, then the overall system control unit may react by reducing the quality level of this or some other less important algorithm, i.e. another SVA.

The invention along with a brief starting introduction to the prior art will be explained more fully below in connection with preferred embodiments and with reference to the drawings, in which:

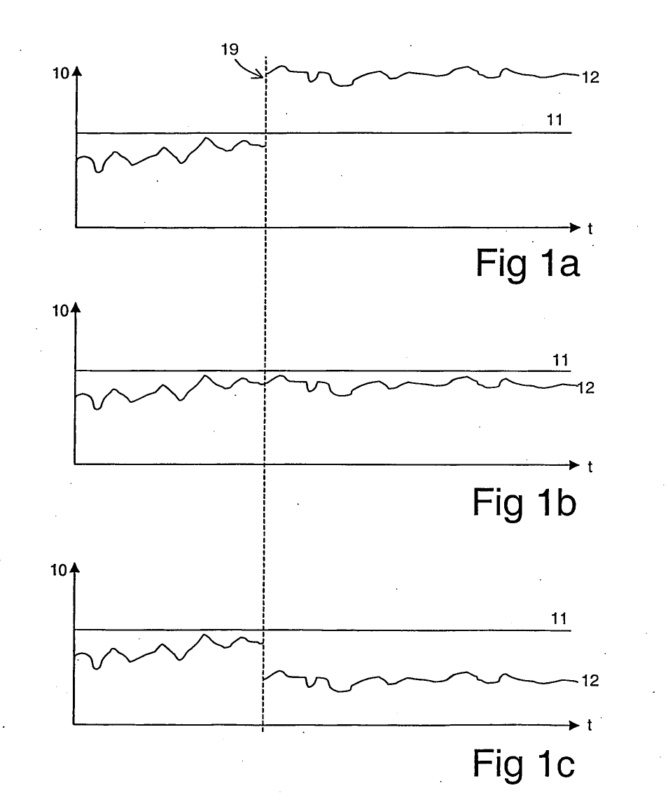

FIG. 1 shows prior art: after a scene change the resource usage (load) of an algorithm may increase, remain the same, or decrease;

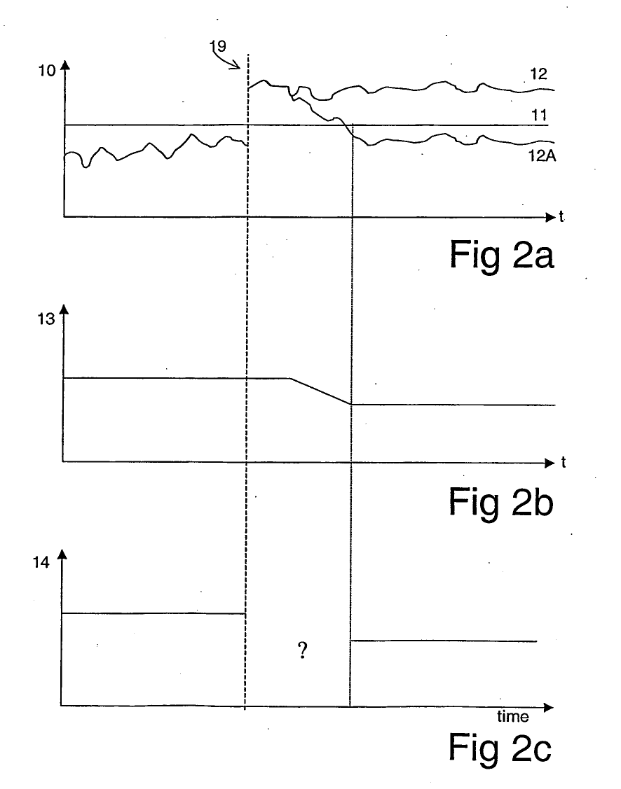

FIG. 2 shows possible resource usage, assigned quality level, and output quality of an algorithm before and after the scene change;

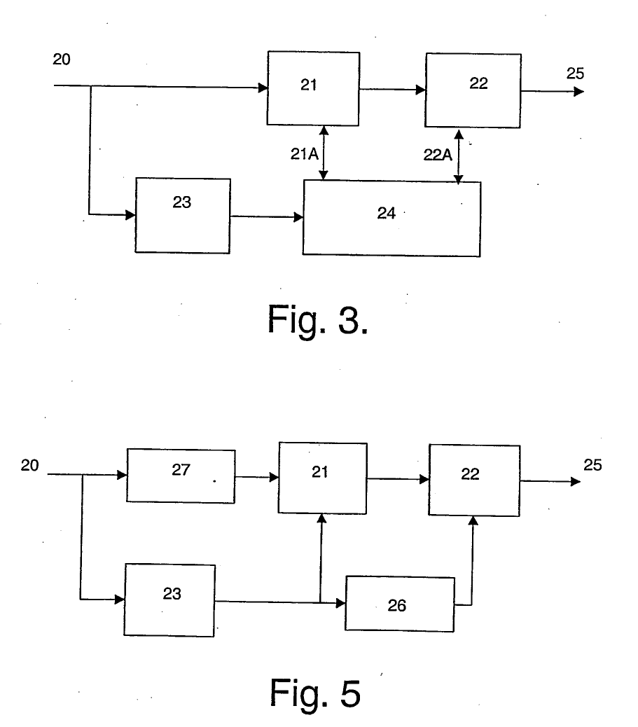

FIG. 3 shows a system for shot or scene change adaptive quality control;

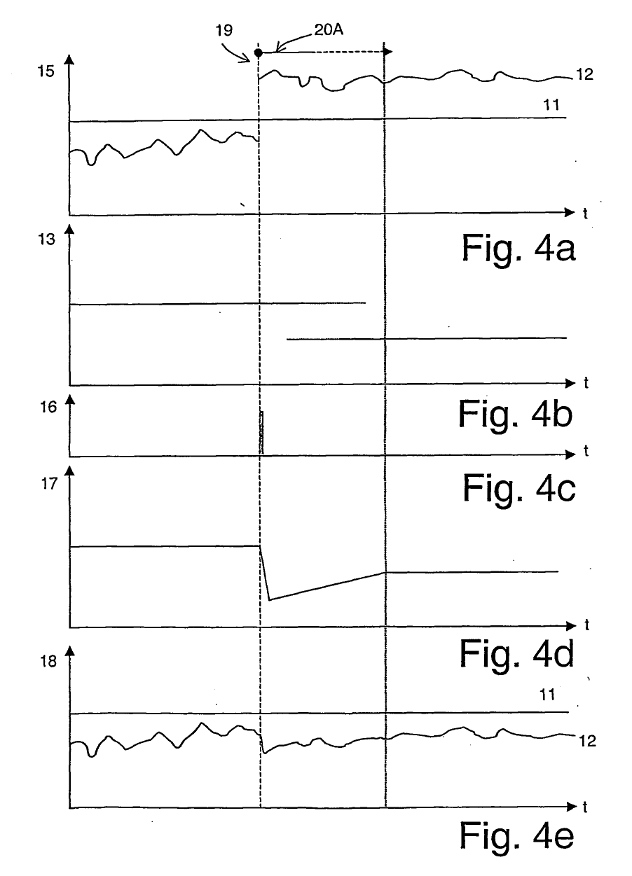

FIG. 4 shows resource usage, assigned and realized quality level, and actual resource usage before and after a shot or scene change;

FIG. 5 shows block diagram for direct shot or scene change adaptive quality control with group delay compensations;

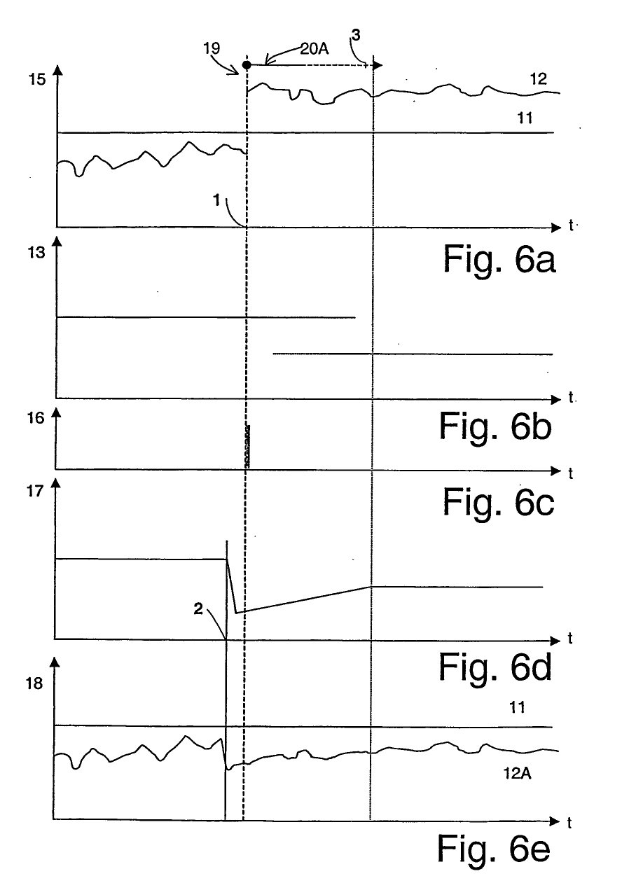

FIG. 6 shows resource usage, output quality and quality level of an algorithm before, and after a shot or scene change, starting adaptive quality control prior to, at or after the shot or scene change; and

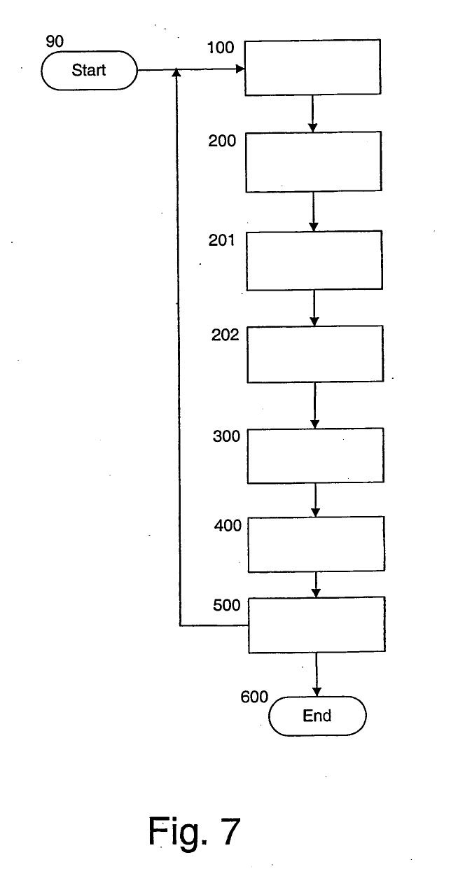

FIG. 7 shows a method of processing a media signal in a media system with overload protection.

Throughout the drawings, the same reference numerals indicate similar or corresponding features, functions, etc.

The term of scene change may be further expanded to cover also situations of a shot change. The shot change—as compared to the scene change—is about change(s) within the scene, e.g. different views of people and /or different views in a room.

FIG. 1 shows prior art: after a scene or shot change the resource usage (load) of an algorithm may increase, remain the same, or decrease. Reference numeral 10 shows resource usage on the Y-axis, reference numeral 11 shows the assigned budget; t, the time on the X-axis, and reference numeral 12 shows the currently resource usage before and after said scene change.

Generally, there are - as discussed - three outcomes for the resource usage or load of an algorithm during the scene or shot change: an increase (a), no change (b) or a decrease (c). This is known from the prior art; in this document, the scenario that the load of an SVA increases after a scene or shot change is primarily considered, since this is the most critical case. The implication of no or decreased loads after scene or shot changes will be explained at the end of this document. If the load increases and the available resources are insufficient then the algorithms are riming behind, leading to a non-optimal system behavior, it may even cause time critical deadline(s) to be missed in the processing of the algorithm(s).

There may be algorithms whose load is dependent on statistical variations of certain parameters (e.g. motion and details). Statistical variations of the above-mentioned types of image contents are exhibited particularly after scene or shot changes.

FIG. 2 also shows the possible resource usage, assigned quality level, and output quality of an algorithm before and after the scene or shot change. As compared to FIG. 1, reference numeral 12A shows an example of soft quality level adaptation, in which the resource usage is slowly decreased after the scene or shot change, reference numeral 19. In this case of load increase—the overall system control unit, discussed in the introduction, may be notified (via a monitoring facility) and may then react by looking for a new optimum. The overall system control unit may allow the increase of budget for the SVA, or request from the SVA to reduce its quality level at once or slowly so that its resource needs may be accommodated by the available resources. The anticipation of a load increase and the reaction of the overall system control unit may require some time. However, even if this time is short the slow-down in processing may have a long-time effect in the output quality since the system for some time is performing under non-optimal conditions—as indicated in section c of the figure—causing the problem(s) previously stated.

The basic idea of the present invention is related to the observation that upon a scene or shot change, it takes a while before the human visual system (HVS) adapts to the new scene or shot. As a consequence, especially with data dependent video algorithms, it is possible to temporarily reduce the quality level of the output during a scene or shot change, exploiting this temporal lack of sensitivity of human perception. The goal is to stay within the assigned budget after sudden changes in resource needs with an implementation of such a system.

So far, scene or shot changes have only been discussed. According to the invention, the term of scene or shot change may be further expanded to cover the more general case of a structural load change. The structural load change—as compared to the scene change—is about change(sof the average load, which last for a longer time period, e.g. more than a few images in case of video processing.

FIG. 3 shows a system for structural load change adaptive quality control. In the figure a block diagram of said system is shown. It includes only two scalable video algorithms (SVAs), a structural load change detector or indicator (e.g. a shot or scene change detector or indicator), and an overall system control unit. Reference numeral 20 shows video input, reference numeral 21 is a first scalable video algorithm, SVA1, reference numeral 22 is a second scalable video algorithms, SVA2, reference numeral 23 is the structural load change detector, reference numeral 24 is the overall system control unit and reference numeral 25 video output; these reference numerals also apply to FIG. 5. Only two SVAs are shown for illustrative purposes, more may be applied. For simplification, blocks for group delay compensation are assumed and are therefore not explicitly shown. These will be shown in FIG. 5. The SVAs include functions for video signal processing and have video inputs and video outputs. A separate input is required to control the resource and quality behavior of the functions at run-time, and a feedback, reference numeral 21A or 22A, for at least one progress information may be required for monitoring. In other words, reference numerals 21A and 22A may be used for progress monitoring. The structural load change detector may notify the overall system control unit about structural load changes, and the overall system control unit then processes this information. The notification for a structural load change is useful to the SVAs whose load is data dependent. The overall system control unit notifies the appropriate SVAs at the appropriate time and performs the necessary optimizations on time.

FIG. 4 shows resource usage, assigned and realized quality level, and actual resource usage before and after a shot or scene change (or structural load change). The figure shows a possible timing diagram for the system from FIG. 3. Reference numeral 15 shows the resource usage without quality level adaptation, reference numeral 16 shows the shot or scene change(or structural load change), reference numeral 17 shows the realized quality level and reference numeral 18—as opposed to reference numeral 15—shows the resource usage with quality level adaptation in a preferred embodiment of the invention. Further, reference numeral 20A shows the previously mentioned HVS adaptation (time). The resource usage (FIG. 4a) may increase after a shot or scene change and the resource requirements may then become higher than the assigned budget permits. The overall system control unit may need some time to calculate and assign a new, lower quality level to the SVA in order to stay within budget (FIG. 4b). Because of the shot or scene change notification (FIG. 4c), the realized quality level may immediately drop (FIG. 4d). Such an action may result in reduced resource usage and speeding up of the processing of the SVA- The realized quality level should then be increased in order the SVA to attain its initial or new assigned output quality level. The actual resource usage with the realized quality level adaptation in a preferred embodiment of the invention is depicted in FIG. 4e. The decrease and increase in quality level of the SVA should be performed within a short time due to previously mentioned HVS characteristics. Immediately after the shot or scene change, the resource usage may even drop, and it subsequently adapts slowly. A slight resource increase may be possible, but far below the resource increase without said shot or scene change adaptation.

FIG. 5 shows a block diagram for direct shot or scene change adaptive quality control with group delay compensations. An alternative block diagram to FIG. 3 is shown in this figure. In addition to FIG. 3, reference numerals 26 and 27 group delay compensations are shown. Only two group delay compensations are shown for illustrative purposes, more may be applied when appropriate in a larger system. The notification for a shot or scene change is sent by the shot or scene change detector. This information can be passed to the following SVAS. The group delay compensations may ensure that the SVAs receive the shot or scene change information at the appropriate time. The adaptive quality control may be part of the shot or scene change detector or part of each SVA. Image quality degradation may be used on both sides, shortly before and after shot or scene changes. Image quality degradation shortly before shot or scene changes may be possible, because the HVS immediately concentrates on the new image content. A timing diagram for this particular case is provided in the next figure.

FIG. 6 shows resource usage, output quality and quality level of an algorithm before and after a shot or scene change, starting adaptive quality control prior to, at or after the shot or scene change. Compared to FIG. 4, which also showed resource usage, output quality, this figure shows the adaptive quality control, but also possibly prior to and after the shot or scene change. In particular, reference numeral 12A shows the resource usage with quality level adaptation prior to the shot or scene change in a preferred embodiment of the invention. Reference numeral 1 shows the point in time where the shot or scene change occurs or, in advance, is determined to take place. Although - as indicated in the figure - reference numeral 2 is shown before the time point of reference numeral 1 - it may generally be decided to decrease an assigned quality level, reference numeral 13, at three, alternative possible points in time: firstly, at a point in time which comes before the shot or scene change; secondly, at the point in time coinciding with the shot or scene change; thirdly, at a point in time which comes after the shot or scene change. In the event that - still as indicated in the figure - reference numeral 2 is determined to come before the time point of reference mnueral 1, i.e. prior to the time point for the shot or scene change, then, correspondingly, the rerence numeral 17 shows a decrease - starting at the time point of reference numeral 2 - of the realized quality level prior to the shot or scene change. After shot or scene change(s), quality degradation may be possible because of said HVS adaptation time, generally ending in the time point of reference numeral 3. In other words, by means of the system control unit, the assigned quality level of at least one scalable algorithm may the be increased again in a third point in time - after the second point in time, but before the time point of reference numeral 3 - whereby a realized quality level, reference numeral 17, may be stable, before the adaptation time of the human visual system (20A) is elapsed since said second point in time.

The applied time slots before a shot or scene change and after a shot or scene change may be different. It is convenient to have a shorter time slot before the shot or scene change compared to the time slot applied after the shot or scene change. After the shot or scene change, an exponential increase of the quality, typical for recursive filters, may be appropriate. The time slot for unproblematic quality degradation is expected to be about 50- 100 ms before shot or scene changes, and 100-200 ms after shot or scene changes. With respect to the timing otherwise applied in signal processing of video signals, said time slots are quite long.

As was previously mentioned, after a shot or scene change the load of an SVA may increase, stay the same or even decrease. It may be appropriate to reduce the quality of a data dependent SVA upon notification of a shot or scene change without first checking whether the load increases; with the shown system the load of a data dependent SVA will always decrease temporally (compared to the non-adaptive behavior), and then increase to its assigned initial or new quality level. However, such an action has much less impact on the system's performance than if no action was taken.

For quality degradation during shot or scene changes, the SVAs may be divided into at least two categories:

In the first category, algorithms, which influence the output quality over time. If quality reduction occurs to these SVAS, then the quality increase over time may be affected due to error propagation.

In the second category algorithms that do not influence the output quality over time. With these, quality degradation may be non-critical during scene shot or channel changes, since quality degradation does not propagate over time.

In a preferred embodiment of the invention, it is preferred to perform quality degradation on SVAs (or functions of an SVA) of the above-mentioned second type.

Generally, the overall system control unit controls by means of the following steps:

Firstly, from an input stream, information about structural load changes from said input may be derived as early as possible within a video processing chain;

Secondly, said information, generally, may then be trnnsferred to the overall system control unit; and

Thirdly, the overall system control unn, on basis of said information, may currently optimize the overall output quality and the resource usage.

Similarily, the same steps may generally be applied when the point(s) in time for a structural load change is / are to be determined prior to the actual structural load change.

For cost-efficiency on a programmable platform, the overall system control unit may allocate budgets for algorithms to process data based on average or above average resource usage. The load of some algorithms may be data-dependent The load of the algorithms may increase after shot or scene changes as shown in figure Ia.

If the available resources are not sufficient, then the algorithms are runnng behind leading to non-optimal, undesired system behavior as shown in FIG. 2c. The time between the anticipation of the load increase and the reaction by the overall system control unit may have a long-time effect on the output quality, since the system for some time is performing under non-optimal conditions as shown in FIG. 2c.

The load of an algorithm may increase after a structural load change, e.g. shot or scene change. The notification about a structural load change may be performed by the structural load change detector or indicator that may pass this information to the following algorithms, before even the shot or scene change occurs to them due to a path latency as shown in FIGS. 3 and 5.

Upon shot or scene change notification, the shot or scene change detector, the overall system control unit, or the SVAs control parts may reduce their realized quality level by selecting the appropriate processing configuration as shown in FIGS. 4c and 4d. Such an action may result in reduced resource usage as shown in FIG. 4 and then speed up the processing of SVAS. The realized quality may then be increased to the new appropriate output quality level.

The decrease and increase in quality level of an SVA may be performed within a short time, taking the HVS adaptation time into account as shown in FIG. 4d.

The main advantage of the invention is that a short decrease and increase in the realized output quality may have no or little negative effects due the adaptation time of the human visual system, while freeing system resources to provide robustness and stability; and since the HVS immediately concentrates on the new image content, degradation of image quality may also be possible even shortly before shot or scene changes as shown in FIG. 6. In this way, more free resources may be assured, which may help to firther increase robustness and stability of the system.

It may be preferred to perform quality reduction to SVAs or functions of SVAs which have no influence on temporal quality degradation.

FIG. 7 shows a method of processing a-media signal in a media system with overload protection. In said method, the media signal reference numerals 20 and 25, is processed in a media system, the media system may be a multimedia consumer terminal, a personal computer, a digital TV, a Set top box or a display.

In step 90, the method is started. Variables, flags, buffers, etc., keeping track of points in time, the various stages of the media signal, assigned quality level(s), realized quality level(s), etc, on said media system are set to default values. When the method is started a second time, only corrupted variables, flags, buffers, types etc, are reset to default values.

In step 100, a system control unit may monitor a progress and a resource usage of the processing of the media signal. The progress - as previously discussed - may be reference numeral 21 A or 22A from FIG. 3. The system control unit may have to monitor the resource usage to be able to recognize the current status. After a structural load change, monitoring may provide the information to calculate and adapt to a new quality level. Monitoring may be done e.g. in this way: The SVA reports the finish of processing of a chunk of data, e.g. finishing the processing of a field or frame. The system control unit may have an assigned budget and may know the consumed budget for the processing of said chunk of data. With this information the system control unit may calculate the performance. These performance calculations may give results for a very small time period (e.g. field or frame), and may fluctuate due to data dependencies. For this invention, these short-time fluctuations are not of interest, but more a longer-term result is of interest, taking several short-term calculations into account. Averaging short-term calculations over time gives a better measure for the averaged resource usage. On that basis, a new quality level may be calculated. From the calculation (average over time) it can be seen that in case of structural overloads the system control unit is not able to react at the very beginning of a structural overload. This is the reason, why a scene change detector (or structural load detector) may help to protect the media system, i.e. to avoid overload or system crash.

In step 200, a structural load control unit may determine a first point in time for a substantial load change of content Step 200 constitutes a generalisation of steps 201 and 202. Said substantial load change (of content) may be understood as consequence of substantial different load due to a scene change or a shot change. The scene change may be understood as the change from one scene (e.g. in a movie or film) to another scene, whereas the shot change may be a change within a scene, a change from the view of one person to a view, i.e. another shot, of another person. Said first point in time was indicated in FIG. 6 with reference numeral 1 corresponding to reference numeral 19, the scene or shot change. In other words, before the actual event occurs of said the scene or shot change, the point in time (i.e. said first point in time) is here in this step determined prior to the real time event of the first point in time.

In step 201, information about at least one future-visual change of the media signal may be derived by the structural load change detector or indicator in the media system.

Of course, several visual changes of the media signal may be possible to determine, especially due to the nature of the media signal, when this is a live motion movie with scene changes and / or with different shots of various people. At least one of said changes may then be derived by said detector or indicator to an information, which is prepared to be transferred to the system control unit Corresponding to many visual changes of the media signal, correspondingly much information about point in times may be derived. It may further be the case that said visual change (with corresponding derivable point in time) is determined by means of various statistical computations of the media signal, e.g. wherein mean value, spread, spreading, variation, etc., may be considered.

In step 202 - as discussed in the foregoing step - said derived information may then be transferred to the system control unit.

In step 300, a second point in time based on the first point in time may be determined by the system control unit. As was discussed in FIG. 6 the second point in time may be different or like the first point in time. Generally, one of three possibilities may be applied for the second point in time: firstly, the second point in time may be determined as a point in time before the shot or scene change, i.e. before the first point in time; secondly, at the point in time for the shot or scene change, i.e. the first and the second point in time is the same; thirdly, at a point in time after the shot or scene change, i.e. the second point time may be determined after the first point in time. In all cases, the second point in time may be determined in relation to said first point in time, whereby, further, a period for the HVS may be considered, since - as will be discussed - the decrease and the subsequent adapting of quality level, especially the realised quality level (reference numeral 18 of FIG. 6) may have to be completed within a period related to said HVS.

In step 400, the system control unit may decrease an assigned quality level of at least one scalable algorithm at the second point in time. As was previously discussed in FIGS. 3 and 5, the media system may comprise a number of scalable algorithm (SVA's), and in order to distribute and to balance resources properly (depending on the assigned quality level(s)), said system control unit may decrease the assigned quality level for one or more of the scalable algorithms in the media system; said decrease may be accomplished at the previously determined second point in time. Said decrease may be accomplished without first checking whether the load of resources actually increases. It is hereby an advantage of the invention, in particular in this step and-at the second point in time that resource or budget overload is prevented since said assigned quality level is decreased, and correspondingly fewer resources are required; thus said overload is prevented.

In step 500, the system control unit may adapt the assigned quality level of at least one scalable algorithm at or till a third point in time. As a consequence, a realized quality level will subsequently become stable shortly thereafter, wherein a realized quality level (17) is expected to become stable within a period of adaptation time. It may become stable preferably before the adaptation time of the human visual system has elapsed since said second point in time. In other words, as opposed to the foregoing, in this step said assigned quality level is adapted again at or till the third point in time, but the adapting has to take place at such point in time that said realized quality level is duly stable around the period for the HVS has elapsed since said second point in time. As an example, when time recursive filters are processed in one of the scalable algorithms in the media system, the realized quality level may increase exponentially after said adapting in the assigned quality level.

The quality level after said adapting of the assigned quality level, i.e. the realized quality level, when stable, may be higher or lower than the quality level before the decrease of the assigned quality level since the system control unit continuously performs scalable video processing in order to balance resources with quality. After a scene or shot change has been detected, the quality level of an SVA may drop immediately, but the amount of resource reduction may not be fixed or known. Therefore, there may be an aim for resource usage below the assigned budget Usually, the later assigned quality level - due to said adapt - may be higher and as a consequence the quality level for the SVA again may have to be increased again. However, also the opposite is possible, i.e. that still the resources used are above the budget. In the latter case, the assigned quality level may frther have to be decreased Usually, the method will start all over again as long as the media system are powered and still have a media signal to process. Otherwise, the method may terminate in step 600; however, when the media system is powered again, etc, the method may proceed from step 100.

Said media system may be a multimedia consumer terminal such as a PC, a Digital TV set, a Settop-Box or a Display capable of performing scalable video processing with video algorithms designed to balance resources to quality and further to take the mentioned structural load changes, e.g. scene or shot changes, into account when resources are allocated to obtain a corresponding quality level without overload or crash.

A computer readable medium may be magnetic tape, optical disc, digital video disk (DVD), compact disc (CD record-able or CD write-able), mini-disc, hard disk, floppy disk, smart card, PCMCIA card, etc.

1. A method of processing a media signal in a media system, the method comprising the steps of: - monitoring, by a system control unit, a progress and a resource usage of the processing of the media signal; - determining, by a structural load control or indicator unit, a first point in time for a substantial load change of a content; - determining, by the system control unit, a second point in time based on the first point; - decreasing, by the system control unit, an assigned quality level of at least one scalable algorithm at the second point in time; and - adapting, by the system control unit, the assigned quality level of at least one scalable algorithm at or till a third point in time, wherein a realized quality level will become stable within a period of adaptation time.

2. A method according to claim 1, characterized in that the step of determining a first point in time comprises the steps of: - deriving, by the structural load control or indicator unit, information about at least one future visual change of the media signal; and transferring, by the structural load control or indicator unit, said information to the system control unit.

3. A method according to claim 1 or 2, characterized in that the scalable algorithm is without error propagation.

4. A method according to any one of claimo 1 through-claim 1, characterized in that the second point in time comes before the first point.

5. A method according to any one of claims 1 through claim 1, characterized in that the second point in time coincides at the first point.

6. A method according to any one of claims 1 through-claim 1, characterized in that the second point in time comes after the first point.

7. A method according to any one of claims 1 throuh-6claim 1, characterized in that the period for the adaptation time is less than one second.

8. A method according to any one of claims 1 through claim 1, characterized in that the media system is as a PC, a Digital TV, a Settop-Box or a Display.

9. A computer system for performing the method according to any one of claims 1 through 8claim 1.

10. A computer program product comprising program code means stored on a computer readable medium for performing the method of any one of claims 1 through 8claim 1 when the computer program is run on a computer.

11. A media system for processing a media signal comprising: - means for monitoring a progress and a resource usage of the processing of the media signal; - means for determining a first point in time for a substantial load change of a content; - means for determining a second point in time based on the first point; - means for decreasing an assigned quality level of at least one scalable algorithm at the second point in time; and - means for adapting the assigned quality level of at least one scalable algorithm at or till a third point in time, wherein a realized quality level will become stable within a period of adaptation time.

12. A media system according to claim 11, characterized in that the means for determining a first point in time comprises: - means for deriving information about at least one future visual change of the media signal; and means for transferring said information to the system control unit.
